(19) United States
(12) Patent Application Publication
(10) Pub. No.: US 2021/0169021 A1
(43) Pub. Date: Jun. 10, 2021

(54) RICE SEEDLING SUBSTRATE AND PREPARATION METHOD THEREOF

(71) Applicant: Zhejiang Academy of Agricultural Sciences, Zhejiang (CN)

(72) Inventors: Chunlai Hong, Zhejiang (CN); Yanlai Yao, Zhejiang (CN); Jianbin Cheng, Zhejiang (CN); Weiping Wang, Zhejiang (CN); Fengxiang Zhu, Zhejiang (CN); Xiaoyang Chen, Zhejiang (CN); Weijing Zhu, Zhejiang (CN); Xinjian Zheng, Zhejiang (CN)

(73) Assignee: Zhejiang Academy of Agricultural Sciences, Zhejiang (CN)

(21) Appl. No.: 17/034,568

(22) Filed: Sep. 28, 2020

(30) Foreign Application Priority Data
Nov. 1, 2019 (CN) 201911060546.5

(51) Int. Cl. A01G 24/22; C05D 1/00; A01G 22/22; A01C 14/00; A01G 27/00; A01G 9/029

(52) U.S. Cl. CPC A01G 24/22; C05D 1/00; A01G 9/0293; A01C 14/00; A01G 27/008; A01G 22/22

(57) ABSTRACT

The present invention relates to a rice seedling substrate and a preparation method thereof, which is of the technical field of rice planting. The rice seedling substrate according to the invention was prepared from the raw materials includes the following by volume: 40-60% of dredging sediment, 30-50% of vegetable straw, and 10-30% of hickory shell. The rice seedling substrate according to the invention can not only turn waste into treasure to improve the recycling rate of sediment and agricultural and forestry waste resources, but also save the limited cultivated soils, reduce the production cost of rice seedling substrate, and promote the healthy and sustainable development of rice planting. Therefore, The inventive substrate has significant benefits in terms of economics, sociology and ecology.

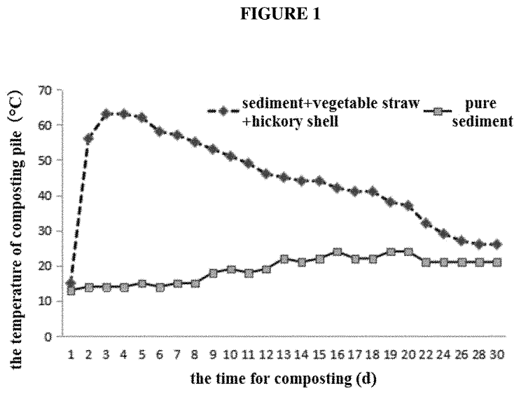

### CROSS REFERENCE TO RELATED APPLICATION

This application claims the benefit of Chinese Patent Application No. 201911060546.5, filed Nov. 1, 2019, which is incorporated herein by reference in its entirety.

### TECHNICAL FIELD

The invention relates to the technical field of rice planting, and in particular to a rice seedling substrate and a preparation method thereof.

### BACKGROUND ART

In recent years, the rural labour in China has shifted to secondary and tertiary industry in great quantities, resulting in labour shortage and price rising. Furthermore, rice production has low comparative benefit. In view of this, the proportion of machine planting replacing traditional artificial planting is increasing. The rice drought seedling industry, being the core of machine planting technology, is developing rapidly, while the traditional rice drought seedling technology mostly takes the paddy soil as the rice seedling soil. Soil resources are non-renewable. Continuous digging of paddy soil will result in the continuous reduction in plough layer, and influence the growth of field crops. In addition, the soils obtained from different regions may face problems such as uneven fertility and soil-borne diseases. With the wide spread of rice machine-planting technology, the problems of the difficulty in collecting soil, complicated working procedure, unstable seedling quality during the seedling raising as well as the failure to realize large-scale planting and the like are increasing. At present, there is no novel seedling material that can replace the soil to reduce the dependence of rice seedling on paddy soil, which is potentially harmful to the rice production and the protection of cultivated land soil resources in the future.

### SUMMARY OF THE INVENTION

The invention aims at providing a rice seedling substrate and a preparation method thereof, and specifically provides a method for the resource utilization of dredging sediment and agricultural and forestry waste, so as to solve the problems that it is difficult to dispose and utilize dredging sediment and agricultural and forestry waste, and meanwhile, in rice drought seedling industry, the demand for soil is increasing, it is difficult to get soil, and soil-borne diseases occurs frequently.

The invention provides a rice seedling substrate, which is prepared from the raw materials comprising the following by volume: 40-60% of dredging sediment, 30-50% of vegetable straw and 10-30% of hickory shell.

Preferably, the dredging sediment is a dredging sediment treated by pressure filtration dehydration.

Preferably, the dredging sediment treated by pressure filtration dehydration has a moisture content of less than or equal to 70%, and has also been crushed and passed through a sieve having a mesh diameter of 0.5 cm.

Preferably, the vegetable straw comprises Cruciferae vegetable straw.

Preferably, the vegetable straw has a moisture content of less than or equal to 65%, which has been crushed and passed through a sieve having a mesh diameter of 0.5 cm.

Preferably, the hickory shell has a moisture content of less than or equal to 30%, which has been crushed and passed through a sieve having a mesh diameter of 0.5 cm.

Preferably, the substrate further comprises 0.25-1.0 g/L of fast released fertilizer and 1-3 g/L of slow released fertilizer.

Furthermore, the invention provides a method for preparing the above rice seedling substrate, comprising the following steps:
mixing raw materials and subjecting the resulting mixture to compost for 25-30 days to obtain a rotten material, wherein the mixture was composted under the following conditions: maintaining the composting pile at a temperature of higher than or equal to 55° C. for more than or equal to 7 days, and after that, gradually reducing the temperature of the composting pile to near ambient temperature to finish the composting; during the composting, turning over the composting pile every 2 days when its temperature is higher than 55° C., and turning over the composting pile every 3 days when its temperature is lower than 55° C.

Preferably, the method additionally comprises the step of adding fast released fertilizer and slow released fertilizer after obtaining the rotten material.

Furthermore, the invention provides a method for raising rice seedlings using the above rice seedling substrate or the rice seedling substrate obtained by above method, comprising the following steps:
loading the rice seedling substrate into a rice seedling tray, sowing rice seeds on the surface of the substrate, and then covering the rice seeds with the substrate until no seed exposed; and
sprinkling tap water until the water oozes out from the bottom of the rice seedling tray, and keeping replenishing water during the seedling raising.

The invention provides a rice seedling substrate. Compared to conventional rice seedling raising using paddy soil as the main raw material, the rice seedling substrate according to the invention can not only improve the quality of rice seedlings, but also realize the resource utilization of wastes such as sediment, and significantly reducing the consumption of paddy soil. The use of wastes such as dredging sediment replacing paddy soil as the rice seedling substrate has a great significance for improving the local ecological environment, facilitating watershed pollution control, and improving the economic benefits for the disposal and utilization of wastes such as dredged sediment, hickory shell and vegetable straw. The rice seedling substrate according to the invention can not only turn waste into treasure to improve the recycling rate of sediment and agricultural and forestry wastes, but also save the limited cultivated soils, reduce the cost of producing rice seedling substrate, and promote the healthy and sustainable development of rice planting. Therefore, the rice seedling substrate according to the invention has significant benefits in terms of economics, sociology and ecology.

### BRIEF DESCRIPTION OF THE DRAWINGS

FIGURE shows the dynamic change of the temperature for composting pile with different substrate materials provided by the invention.

### DETAILED DESCRIPTION OF THE EMBODIMENTS

The invention provides a rice seedling substrate, which is prepared from the raw materials comprising the following by volume: 40-60% of dredging sediment, 30-50% of vegetable straw, and 10-30% of hickory shell.

The rice seedling substrate according to the invention comprises 40-60% of dredging sediment by volume, preferably 40-50%, and most preferably 50%. The dredging sediment of the invention is preferably a dehydrated dredging sediment, the safety indexes of which meet the standard for sludge used in agriculture (CJ/T309-2009). According to the invention, the dredging sediment is a dredging sediment treated by pressure filtration dehydration, which preferably has a moisture content of less than or equal to 70%. According to the invention, the dredging sediment preferably was also crushed and passed through a sieve having a mesh diameter of 0.5 cm after the pressure filtration dehydration.

The rice seedling substrate according to the invention comprises 30-50% of vegetable straw by volume, preferably 30-40%, and most preferably 30%. According to the invention, the vegetable straw comprises Cruciferae vegetable straw such as Cauliflower, Chinese kale and tuber mustard. According to the invention, the vegetable straw has a moisture content of less than or equal to 65%, which has been crushed and passed through a sieve having a mesh diameter of 0.5 cm.

The rice seedling substrate according to the invention comprises 10-30% of hickory shell in volume, preferably 10-20%, and most preferably 20%. According to the invention, the hickory shell has a moisture content of 30%, which has been crushed and passed through a sieve having a mesh diameter of 0.5 cm.

According to the invention, the substrate also comprises 0.25-1.0 g/L of fast released fertilizer and 1-3 g/L of slow released fertilizer, and most preferably 0.5 g/L of fast released fertilizer and 2 g/L of slow released fertilizer. According to the invention, the fast released fertilizer preferably includes nitrogen, phosphorus and potassium in the ratio of 20:10:20. The slow released fertilizer preferably includes nitrogen, phosphorus and potassium in the ratio of 20:20:20. There is no special limitation on the sources of the fast released fertilizer and the slow released fertilizer in the present invention. It is possible to use any conventional commercially available products for fast released fertilizer and slow released fertilizer that are well known to a person skilled in the art. According to the invention, the fast released fertilizer and the slow released fertilizer are added into the rice seedling substrate. According to the invention, the fast released fertilizer and the slow released fertilizer can meet the demand for rice seedling on the nutrients during its growth.

Furthermore, the invention provides a method for preparing the above rice seedling substrate, comprising the following steps:
mixing raw materials and subjecting the resulting mixture to compost for 25-30 days to obtain a rotten material, wherein the mixture was composted under the following conditions:

maintaining the composting pile at a temperature of higher than or equal to 55° C. for more than or equal to 7 days, and after that, gradually reducing the temperature of the composting pile to near ambient temperature to finish the composting; during the composting, turning over the composting pile every 2 days when its temperature is higher than 55° C., and turning over the composting pile every 3 days when its temperature is lower than 55° C., thereby ensuring the material to compost uniformly and rot stably.

According to the invention, the method additionally comprises the step of adding fast released fertilizer and slow released fertilizer after obtaining the rotten material. According to the invention, the resulting mixture is preferably stirred fully by means of a mixer.

Furthermore, the invention provides a method for raising rice seedlings using the above rice seedling substrate or the rice seedling substrate obtained by the above method, comprising the following steps:
loading the rice seedling substrate into a rice seedling tray, sowing rice seeds on the surface of the substrate, and then covering the rice seeds with the substrate until no seed exposed; and
sprinkling tap water into the substrate until the water oozes out from the bottom of the tray, and keeping replenishing water during the seedling raising.

According to the invention, the rice seedling tray preferably has a length of 60 cm, a width of 30 cm, and a depth of 5 cm. The rice seedling substrate in the rice seedling tray preferably has a thickness of 3 cm. It is preferable to take 30 g of rice seeds, accelerate their germination in the incubator, sow them on the surface of the substrate uniformly after the seeds sprout, and subsequently cover them with a small amount of substrate until no seeds exposed.

According to the invention, sprinkling tap water into the substrate uniformly is preferably carried out by the means of spraying until the water oozes out from the bottom of the tray. In this period, it is preferred to replenish water depending on the weather. After 25 days, 10 rice seedlings will be randomly selected for each treatment to observe and measure the agronomic traits such as plant height, root length, fresh weight above ground and root weight, and to study the effect of the novel seedling substrate on the quality of rice seedling.

The rice seedling substrate and the preparation method thereof according to the invention will be described in detail with specific examples in the following. The technical solution of the invention includes but is not limited to the following examples.

### Example 1

1. Test of the Use of Dredging Sediment and Agricultural & Forestry Waste Replacing Paddy Soil as Rice Seedling Substrate

1.1 Test Material

The materials are specified as follows: Dredging sediment (being crushed and passed through a sieve having a mesh diameter of 0.5 cm, and having a moisture content of less than or equal to 70%), hickory shell (being dried in the air, and having a moisture content of less than or equal to 30%), Cruciferae vegetable (Cauliflower) straw (having a moisture content of less than or equal to 65%), fast released fertilizer (containing nitrogen, phosphorus and potassium in the ratio of 20:10:20), slow released fertilizer (containing nitrogen, phosphorus and potassium in the ratio of 20:20:20), and rice seeds (Yongyou 538).

TABLE 1
Basic physical and chemical properties
of different substrate materials.

| Substrate | | | | | | | |
|---|---|---|---|---|---|---|---|
| materials | pH | EC(mS/cm) | N(%) | P(%) | K(%) | C(%) | C/N |
| Sediment | 7.14 | 0.223 | 0.05 | 0.17 | 0.92 | 1.31 | 26.2 |
| Hickory | 7.26 | 0.549 | 0.87 | 0.25 | 1.06 | 49.7 | 59.2 |
| shell | | | | | | | |
| Vegetable | 5.89 | 3.49 | 4.15 | 0.55 | 0.86 | 39.6 | 9.54 |
| straw | | | | | | | |
| (Cruciferae) | | | | | | | |

TABLE 2
The measurement results of the safety indexes such
as heavy metals in each substrate materials.

| substrate | | | | | | | | |
|---|---|---|---|---|---|---|---|---|
| materials | Cd | Pb | Cr | As | Hg | Ni | Cu | Zn |
| Sediment | 0.27 | 38.9 | 45.0 | 9.50 | 0.068 | 16.0 | 32.0 | 137.0 |
| Hickory | 0.06 | 0.16 | 0.47 | 0.19 | Not | 0.27 | 2.6 | 4.2 |
| shell | | | | | detected | | | |
| Vegetable | 0.09 | 0.13 | 0.36 | 0.11 | Not | 0.64 | 4.3 | 14.6 |
| straw | | | | | detected | | | |
| (Cruciferae) | | | | | | | | |

1.2 Harmless and Stable Treatment of Substrate Materials

In view of the fact that it is impossible to realize harmless and stable treatment of sediment completely due to its low content of organic matter and total nitrogen and the difficulty of achieving high temperature (>55° C.) when the sediment was composted directly, the present invention has achieved the harmless treatment of substrate materials by mixing the dredging sediment with hickory shell and vegetable straw for piling and co-composting. Specifically, in the present invention, the dehydrated sediment was mixed with hickory shell and vegetable straw scientifically in the volume ratio as defined in the invention, and the resulting mixture was stirred uniformly and subsequently piled to form a pile having a windrow shape with a width of 2 m and a height of 1.2 m. The temperature of the composting pile reach 56° C. at the next day and 64° C. at the third day, and the temperature above 55° C. was maintained for 7 days. In this period, the composting pile was turned every 2 days. After that, the composting temperature was reduced gradually, and the composting pile was turned every 3 days. After 30 days, the temperature of the composting pile was reached near ambient temperature, indicating that the harmless treatment of the mixed substrates containing sediment was completed. However, the temperature of the composting pile with pure sediment without vegetable straw and hickory shell always was not higher than 40° C. in the whole composting period, indicating that the temperature of the composting pile with pure sediment is difficult to reach above 55° C. during composting and cannot be treated to be harmless and stable.

1.3 Preparation of Substrate

The following three formulations are used in the experiment:

Formulation 1: CK1, pure sediment (which was crushed, and then piled for 30 days)+0.5 g/L of fast released fertilizer+2 g/L of slow release fertilizer;

Formulation 2: CK2, paddy soil+0.5 g/L of fast release fertilizer+2 g/L of slow release fertilizer; and

Formulation 3: novel rice seedling substrate (50% of sediment+20% of hickory shell+30% of vegetable straw (Cruciferae))+0.5 g/L of fast released fertilizer+2 g/L of slow release fertilizer.

Each substrate material was mixed with fast released fertilizer and slow released fertilizer in the ratio as given in the above formulations, and after mixing uniformly, the mixtures was each loaded into seedling trays to reserve, wherein each mixture was loaded into 4 trays.

1.4 Sowing and Management

After the rice seeds were germinated and sprouted, they were uniformly sowed in each substrate of the above formulation, and the amount of rice seeds in each seedling tray is 30 g. After sowing, the rice seeds was covered with the corresponding substrate soil until no rice seeds exposed. The substrates was sprinkled with tap water and soaked by the water. Then, the water was replenished to the substrates regularly depending on the moisture content of the substrates and the weather. After 25 days from the start of the experiment, the effects of different rice seedling substrates on the qualities of rice seedlings, such as plant height, base stem width, root length, root fresh weight and fresh weight above ground, were studied.

1.5 the Results and Analysis of the Experiment

1.5.1 Effects of Different Raw Material Formulations on the Change in the Temperature of the Composting Pile

The dynamic change of the temperature of composting piles with different substrate materials provided by the invention is shown in FIGURE. From the FIGURE, It can be seen that the temperature of the composting pile with mixed substrate containing sediment (sediment+hickory shell+vegetable straw) reached 56° C. on the next day and 63° C. on the third day, and the temperature above 55° C. was maintained for 7 days. In this period, the composting pile was turned every 2 days. After that, the composting temperature was reduced gradually, and the composting pile was turned every 3 days. After 30 days, the temperature of the composting pile was reached near ambient temperature, indicating that the harmless treatment of the mixed substrates containing sediment was completed. While the temperature of composting pile with pure sediment was always similar to the ambient temperature, indicating that the direct composting using pure sediment could not achieve a high temperature in composting. This is because pure sediment comprises organic carbon and nitrogen available for aerobic microorganisms in a low content, and thus aerobic microorganisms cannot reproduce quickly. In view of this, pure sediment cannot be harmless and rot-stabilized treatment by the aerobic high temperature composting.

Effects of Different Substrate Formulations on the Quality of Rice Seedlings

Effects of different substrate formulations on the quality of rice seedlings are shown in table 3. From the table, it can be seen that the rice seedlings treated by the novel mixed seedling substrate prepared by scientifically mixing the sediment with vegetable straw and hickory shell have the best quality, and exhibit developed rice root system, strong seedling, and wide and green leaves. While the rice seedlings treated by pure sediment have the worst quality, and exhibit weak seedlings, and small and yellow leaves. Although rice seedlings treated by paddy soil have good quality, they are still worse in the comprehensive growth of seedlings than that of rice seedlings treated by the novel sediment seedling substrate. The results indicates that the soil can be completely replaced with the mixed substrate of sediment and agricultural and forestry waste, and the mixed substrate could bring about good application effects.

TABLE 3
Effects of different seedling substrate
on the quality of rice seedlings

| | | Base | Length of | | fresh |
|---|---|---|---|---|---|
| | Plant | stem | the longest | Root fresh | weight above |
| Substrate | height | width | root | weight | ground |
| formula | (cm) | (mm) | (cm) | (g/plant) | (g/plant) |
| Novel rice | 6.8a | 2.21a | 8.2a | 0.13a | 0.24a |
| seedling | | | | | |
| substrate | | | | | |
| (sediment + | | | | | |
| vegetable | | | | | |
| straw + | | | | | |
| hickory | | | | | |
| shell) | | | | | |
| Pure | 5.38b | 1.65b | 6.6b | 0.07b | 0.15b |
| sediment | | | | | |
| (CK1) | | | | | |
| Paddy soil | 7.12a | 1.77b | 8.7a | 0.11a | 0.21a |
| (CK2) | | | | | |

The above are only the preferred embodiments of the present invention. It should be understood that several improvements and retouches can be made for those of ordinary skill in the art without departing from the principles of the present invention, and should be regarded as the protection scope of the present invention.

1. A rice seedling substrate, which is prepared from the raw materials comprising the following by volume: 40-60% of dredging sediment, 30-50% of vegetable straw, and 10-30% of hickory shell.

2. The rice seedling substrate according to claim 1, wherein the dredging sediment is a dredging sediment treated by pressure filtration dehydration.

3. The rice seedling substrate according to claim 2, wherein the dredging sediment treated by pressure filtration dehydration has a moisture content of less than or equal to 70%, and has also been crushed and passed through a sieve having a mesh diameter of 0.5 cm.

4. The rice seedling substrate according to claim 1, wherein the vegetable straw comprises Cruciferae vegetable straw.

5. The rice seedling substrate according to claim 1, wherein the vegetable straw has a moisture content of less than or equal to 65%, which has been crushed and passed through a sieve having a mesh diameter of 0.5 cm.

6. The rice seedling substrate according to claim 1, wherein the hickory shell has a moisture content of less than or equal to 30%, which has been crushed and passed through a sieve having a mesh diameter of 0.5 cm.

7. The rice seedling substrate according to claim 1, wherein the substrate further comprises 0.25-1.0 g/L of fast released fertilizer and 1-3 g/L of slow released fertilizer.

8. A method for preparing the rice seedling substrate according claim 1, comprising the following steps:
mixing raw materials and subjecting the resulting mixture to compost for 25-30 days to obtain a rotten material, wherein the mixture was composted under the following conditions: maintaining the composting pile at a temperature of higher than or equal to 55° C. for more than or equal to 7 days, and after that, gradually reducing the temperature of the composting pile to near ambient temperature to finish the composting; during the composting, turning over the composting pile every 2 days when its temperature is higher than 55° C., and turning over the composting pile every 3 days when its temperature is lower than 55° C.

9. The method according to claim 8, wherein the method additionally comprises the step of adding fast released fertilizer and slow released fertilizer after obtaining the rotten material.

10. A method for raising rice seedlings using the rice seedling substrate according to claim 1, comprising the following steps:
loading the rice seedling substrate into a rice seedling tray, sowing rice seeds on the surface of the substrate, and then covering the rice seeds with the substrate until no seed exposed; and
sprinkling tap water until the water oozes out from the bottom of the tray, and keeping replenishing water during the seedling raising.
